(19) United States
(12) Patent Application Publication
(10) Pub. No.: US 2006/0253279 A1
(43) Pub. Date: Nov. 9, 2006

(54) Method and apparatus of wireless audio playback system

(76) Inventor: Chih-Ta Star Sung, Glonn (DE)

Correspondence Address: Chih-Ta Star SUNG;RM. 308, BLD. 52, NO. 195, CHUNG HSING RD., SEC 4, CHU TUNG TOWNSHIP., HSINCHU COUNTY, 310, TW

(21) Appl. No.: 11/120,808

(22) Filed: May 4, 2005

(51) Int. Cl. G10L 19/12

(52) U.S. Cl. 704/221

(57) ABSTRACT

Audio compression/decompression codec is applied to reduce the data rate during wireless transmission and receiving resulting in higher efficiency of transmission bandwidth which allows scheduled time to turn on and shut off the transmission and receiving devices. The average values of a predetermined amount of audio samples within a pack of audio are inserted into the compressed audio data as references in recovering the audio data. When small amount of audio data are lost during transmission, some recovered audio samples are repeated to represent the lost data within a pack of audio data. Should the variance of a certain amount of data samples are high, some un-compressed audio data will be packed and sent out to maintain the audio quality.

### BACKGROUND OF THE INVENTION

1. Field of Invention

The present invention relates to audio data playback, and more particularly relates to the wireless audio data transmission and playback with audio compression and decompression mechanism to reduce the data amount to be transmit and receive.

2. Description of Related Art

Taking the advantage of the semiconductor technology migration trend, the analog-to-digital (ADC) converter and the digital-to-analog converter (DAC) have driven the digitalized audio to an increasing number of applications including the TV, telephony, Compact Disc (CD) music, DVD, MTV . . . etc. With its top quality of 16 bits per digitized sample, the CD music has been popular for two decades.

Wireless communication technology including Wireless LAN (802.11), Blue Tooth, DECT, RF have made audio data transmission and receiving through air feasible. The audio data stream can be transmitted through air to the destination under communication protocols. The audio player with wireless receiver has convenience in handless and gives one freedom when listening to music. Combing the wireless technology and audio player, the wireless related devices become convenient in headphone, car speakers, home audio, TV . . . etc. The wireless audio playback system includes but not limited to wireless headphone, wireless car speaker.

The prior art wireless audio playback system just transmits audio data stream to the destination of an audio player with wireless receiver as shown in FIG. 1. Drawback of the prior art wireless audio playback system includes the possible loss of audio data with no mechanism of correction and the data rate is high which requires high bandwidth of audio data transmission. Another side effect of the prior art audio playback system of high data rate of audio is the high power consumption in transmitting and receiving data since the wireless transceiver is the device consumers most the power in the whole system.

The present invention of the wireless audio playback system compresses the audio data which reduces the amount of audio data before transmitting, and decompresses the received audio data stream before sending it to the audio player which might include a DAC, Digital-to-Analog-Converter, an amplifier and speaker. A simplified error correction mechanism is also applied to this invention of the wireless audio playback system.

This invention of the apparatus of video recording and playback system provides new video data compression mechanism for video recording and playback system which provides lossless video data reduction or minimizes the rate of data loss and achieves top quality and simplicity in encoding and decoding the video data captured by the image sensor.

### SUMMARY OF THE INVENTION

The present invention is related to an apparatus of wireless audio playback system with audio data compression and decompression mechanism before and after audio data transmission and receiving.
The present invention of the apparatus of wireless audio playback system applies audio compression technique to reduce the amount of audio data to be transmitted through the air under the wireless communication protocol.
The present invention of the apparatus of wireless audio playback system applies audio decompression technique to recover the audio data stream received from the destination before it is sent to other procedure for audio playback.
According to an embodiment of the present invention of the apparatus of wireless audio playback system, a time modulation scheme is applied to schedule specific time slot for audio receiving, audio decompressing and audio playback to minimize the risk of noise coupling.
According to an embodiment of the present invention of the apparatus of wireless audio playback system, when a package of audio data is damaged or lost, an error correction mechanism of repeating the last audio sample of previous audio pack is applied to minimize the impact of error.
According to an embodiment of the present invention of the error correction for the loss of compressed audio data, the averages of a pack of audio data are used to be reference for recovering the audio data.
According to an embodiment of the present invention of the wireless audio playback system, the length of a pack of audio samples varies and dependent on the variance of the audio samples.
According to an embodiment of the present invention of the wireless audio playback system, the un-compression algorithm is applied to some audio samples with high variance of the audio values.
According to an embodiment of the present invention of the wireless audio playback system, the lost audio data is represented by adjacent sample within a pack of audio data.
According to an embodiment of the present invention of the wireless audio playback system, if the compressed audio data are severely damaged or lost, the average values might be taken to represent the audio data instead.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of block diagram of a wireless audio playback system.

FIG. 2 illustrates the block diagram of the present invention of the wireless audio playback system with audio compression and decompression mechanism.

FIG. 3 depicts the procedure of audio data compression and transmission-receiving and decompression.

FIG. 4 depicts a timing modulation scheme of the audio data transmission, receiving, decompressing and playback.

FIG. 5 illustrates the source of possible data loss and a mechanism of error correction of repeating the last audio sample of the previous audio pack.

FIG. 6 illustrates the source of possible data loss and a mechanism of error correction of referring to the averages of an audio pack data.

FIG. 7 depicts the concept of averaging audio data pack which are used to be reference of error correction.

FIG. 8 depicts the concept of repeating a adjacent audio sample to replace the lost data.

FIG. 9 shows the format of an audio stream and related pack data

### DESCRIPTION OF THE PREFERRED EMBODIMENTS

The availability of the wireless communication technology including Wireless LAN (ex. 802.11g), Blue Tooth, DECT, RF has made audio data transmission and receiving through air feasible. The audio player with wireless receiver has convenience of handless and gives one freedom when listening to audio. Combing the wireless technology and audio player, the wireless related devices become convenient in headphone, car speakers, home audio, TV . . . etc.

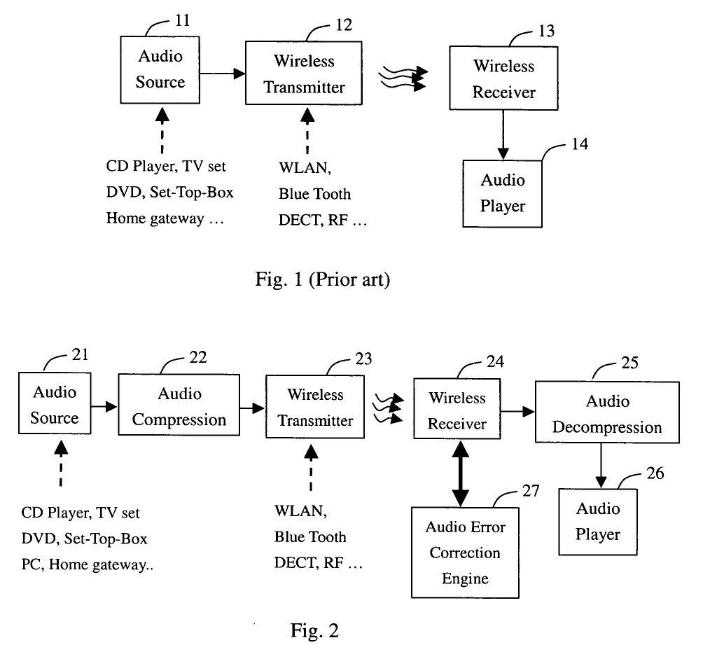

FIG. 1 illustrates the prior art of popular wireless audio playback system. Audio data stream from an audio source 11 which might have audio generated by one of the devices like CD player, TV set, DVD player, Set-top-box, home gateway . . . is connected to a wireless transmitter 12 for transmission. The wireless transmission protocol might include some standards including wireless LAN, (802.11 of IEEE), Blue Tooth, DECT, or other private RF (Radio Frequency). The audio data stream is transmitted through the air by the wireless transmitter under wireless transmission protocol. The receiving end will include a wireless receiver 13 which supports the selected protocol of wireless communication. The receiver obtains the audio stream and sends it to the audio player 14 for playback. An audio player might include a DAC, digital-to-analog-convert, an amplifier and speakers.

The drawback of the prior art wireless audio playback system includes
High amount of audio data of transmitting and receiving dissipates high power consumption and makes the battery life short.
Wireless audio data transmitting and receiving is easy to be interfered by some noise or magnetic field which causes data loss or damage.

Due to the above drawbacks, the prior art wireless audio playback system consumes higher power and worsening audio quality. The present invention of the apparatus of wireless audio playback system overcomes these drawbacks of prior art and makes the system lower power consumption and higher audio quality.

FIG. 2 depicts the present invention of the wireless audio playback system. The audio data from the source 21 of CD player, DVD, STB, TV, PC or a home gateway, is compressed by the audio compression engine 22 which reduced the amount of audio data by a factor ranging from 4× to 20× before it is transmitted out through the wireless transmitter device 23. The wireless receiver 24 obtains the compressed audio data and check with an error correction engine 27 to ensure the received audio data is not lost. The received or error corrected audio data is then reconstructed by an audio decompression engine 25 and sent to the audio player 26 for presentation.

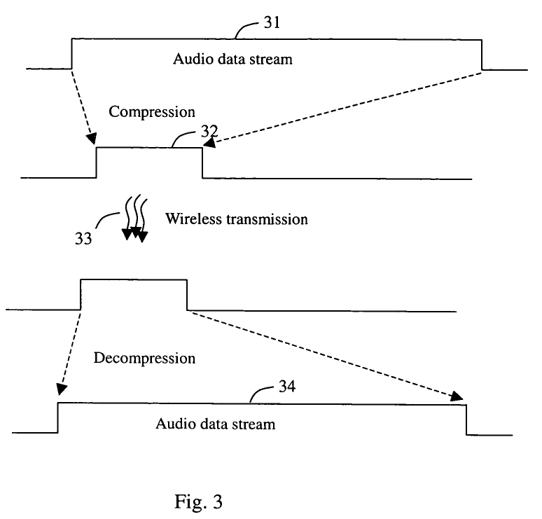

Since the most power consuming circuit of the wireless audio playback system is the wireless transmitter and the receiver, the compression mechanism as shown in FIG. 3 reduces the amount of audio data 31 to shorter pack of data 32 to be transmitted. The audio compression mechanism reduces data amount and helps in reducing the power consumption in the wireless transmitter and receiver 33 and still maintains audio data quality close to the original source by decompressing 34 the received audio data.

Since the air is the media of wireless data transmission, some noise and especially magnetic field might interfere and destroy the package of data. In prior art of the wireless audio playback system, there is no error correction mechanism to overcome this kind of data loss problem, and the audio player just plays the received audio data “as is” which when plays the damaged audio data or the section with lost audio data, one can easily hear noise and uncomfortable audio.

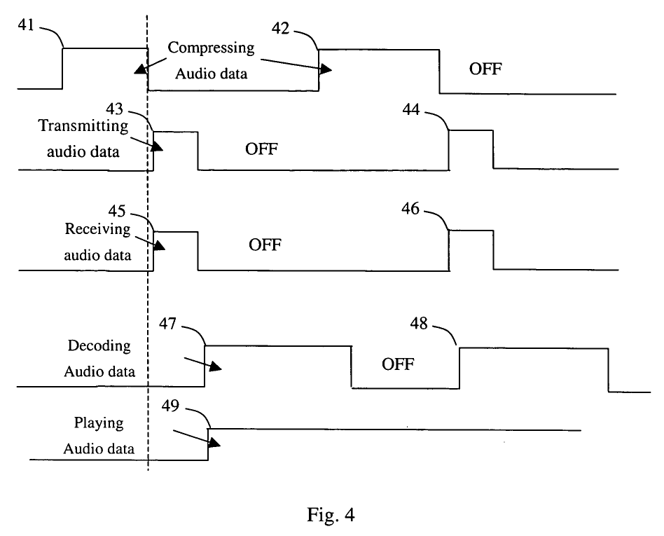

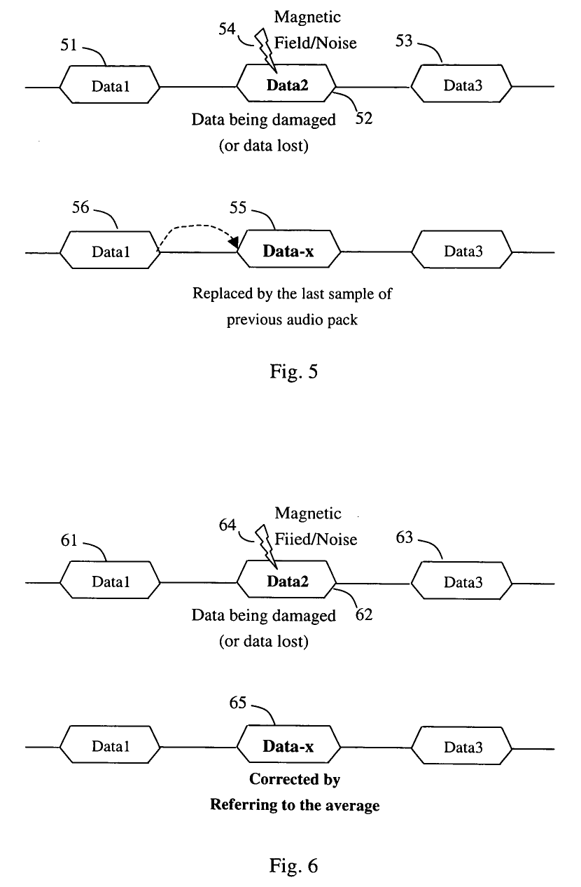

In the present invention of the wireless audio playback system, since the amount of audio data is reduced by the audio compression mechanism, the wireless transmitter and receiver don't have to operate all the time. They operate under a scheduled slot of time and most of the time with this kind scheme named “time modulation” as shown in FIG. 4. To avoid noise coupling which might risk data loss or error and worsening the audio quality, the operations of audio data compression 41, 42 decompression 47, 48 and the wireless data transmitting, 43, 44, receiving 45, 46 work under scheduled different time slots. When the transmitter and receiver are not operating, they enter a stand mode to reduce power and to reduce noise coupling effect.

Some nearby appliances with strong magnetic radiation 54 might causes data loss 52 of the wireless audio transmitting and receiving as shown in FIG. 5. For minimizing the impact of the package loss or damage, in the present invention of the wireless audio playback system, an error correction mechanism is applied to recover the lost audio data. When noise 54 destroys the continuously transmitting compressed audio data packages 51, 52, 53, since the receiving point checks the audio package which has fixed amount of compressed audio data, when the error checking engine finds inconsistence of the length of compressed audio data or completely loss of audio data, the error correction mechanism is enabled to fill the empty space with repeating the last sample 55 of previous pack 56 of audio data which makes the last audio sounds a little longer to minimize a complete error and worsening quality of audio data loss.

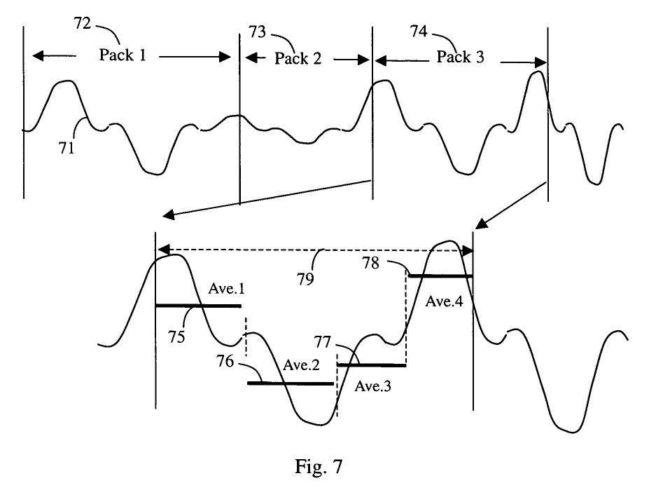

Another error correction mechanism of this invention of the wireless audio playback system is to apply averages of each packed audio data stream to be references of each compressed audio data. When noise 64 damages the continuously transmitting compressed audio data packages 61, 62, 63, or causes audio data loss, in recovering the audio data the compressed audio data will take the average value as the reference value. This mechanism might not be as accurate as some other method like requesting re-submitting, but is a simple quick and efficient mechanism in recovering the lost audio data. A detailed description of the audio lost data recovering is depicted in FIG. 7. A stream 71 of audio data is divided to be packs 72, 73, 74 of audio data with a certain length of pack of audio samples said 64, 128, 256 . . . samples. Each pack of audio samples is compressed independently without correlation between pack of audio data. In compressing audio data, a certain amount of audio samples of a pack 79 of audio data are taken to form the averages 75, 76, 77, 78 of groups of audio samples. For instance, if an audio pack is comprised of 64 audio samples, and every 16 samples are taken into an average, there will be a total of 4 averages of this pack of audio samples. For avoiding long latency delay of error correction which will degrade the audio quality, another mechanism of this invention of the wireless audio playback system takes short length of a pack of audio data and compresses each pack of audio independently. Should error or data loss happened, the impact will be minimized and recovering procedure can be very quick and simple since no correlation between audio packs.

Some audio samples with high degree of variance for a certain length of samples, a mechanism of un-compression is selected and applied to pack the audio samples to avoid degrading the audio quality.

In case of severe data damage or loss, an optional choice for minimizing the impact of degrading audio quality and maintaining shortest latency and keeping simplicity, the average values in the beginning of each audio data “pack” will be extracted to represent the audio data. Even this kind of mechanism does not totally recover the audio data, it maintains a certain degree of audio quality by minimized length of code.

For gaining highest efficiency and minimizing the impact of data loss or data damage, variable length of audio samples are packed as compression unit as shown in FIG. 7 pack1, pack2 and pack 3, 71, 72, 73. Under small variance, the pack length is longer, while shorter pack length will be used for larger variance.

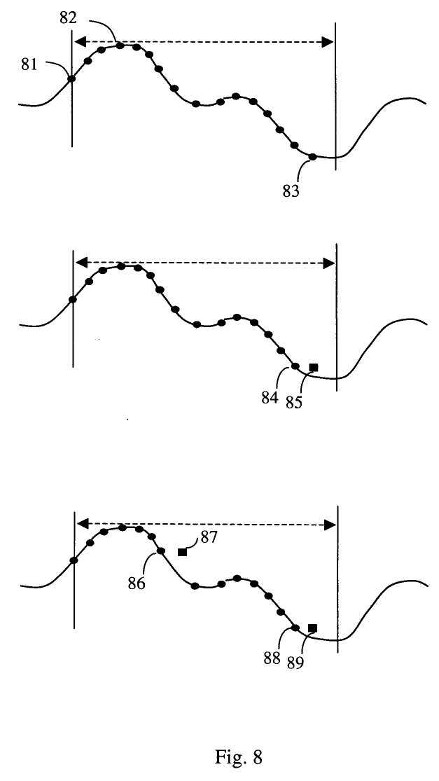

Another method of minimizing the quality impact of audio data loss is to represent the lost audio data by adjacent audio sample. FIG. 8 depicts details of this method. In this example, 16 audio samples 81, 82, 83 form a pack of audio data, when there is one audio data loss happens, the last recovered audio data 84 is repeated 85 to fill up the complete length of the audio pack. In the case of two audio samples are lost, then, the recovered 7^{th} audio sample 86 is repeated to represent the 8^{th} audio sample 87, and the 15^{th} audio sample is repeated to represent the 16^{th} audio sample.

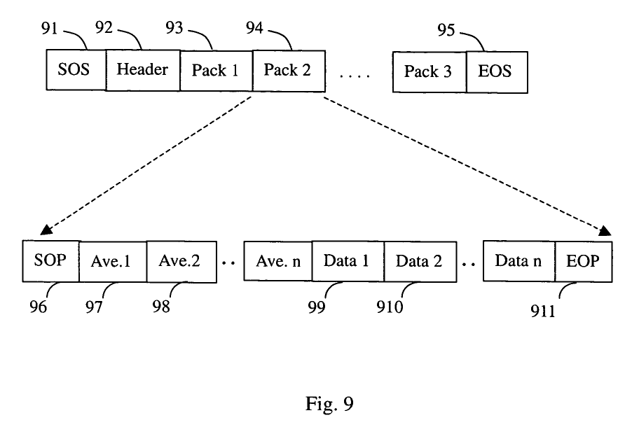

FIG. 9 illustrates the simplified data stream format of the compressed audio data. An audio stream starts from a code names SOS 91, Start Of Stream which is followed by “Header” 92 comprising of a couple byte of data. After the header, a certain amount of packs 93, 94 of compression audio data are interleaved till the End Of Stream, EOS 95 code shows up. A pack of compressed audio data starts by a code named SOP 96, Start Of Pack which is followed by a certain amount of average numbers 97, 98 which are used for reference of recovering or used to roughly represent the value of a group of audio samples. A variable length compressed audio data 99, 910 of each sample are inserted before the EOP 911, End Of Pack shows up.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. An apparatus of audio playback system, comprising:
an audio source which generates the output data stream of the original audio sampled;
an audio compression device for reducing the amount of audio data;
a wireless transmission device transferring the compressed audio data through the air media;
a wireless receiving device receiving the compressed audio data through the air media;
an audio decompression device for recovering the audio data stream; and
an audio playback system which plays the audio stream.

2. The apparatus of claim 1, wherein the stream audio samples are separately packed into plurality of packs of audio data with each pack of data independently compressed.

3. The apparatus of claim 1, wherein the original audio stream is packed into packs of audio data with each pack of data having variable length of audio samples.

4. The apparatus of claim 1, wherein the amount of pack of audio data samples is determined by the variance of that pack of audio data with shorter pack having larger variance and longer pack having smaller variance.

5. The apparatus of claim 2, wherein a predetermined amount of the original audio samples are calculated to generate the average value as reference for recovering the corresponding audio data.

6. A method of audio data playback through wireless data transmission, comprising:
synchronizing the compressed audio data flowing of wireless transmission and receiving;
turning on and off the wireless transmission device and receiving device according to the predetermined time schedule;
turning on and off the audio compression engine according to the predetermined time schedule; and
turning on and off the audio decompression engine according to the predetermined time schedule;

7. The method of claim 6, wherein a predetermined amount of the compressed packs of audio data with variable length will be sent out by a transmission device;

8. The method of claim 6, wherein a predetermined amount of the compressed packs of audio data with variable length will be sent out by a transmission device;

9. The method of claim 6, wherein un-compressed pack of audio audio with variable amount of samples will be sent out by a transmission device;

10. The method of claim 6, wherein a transmission device submits the predetermined amount of the compressed packs of audio data and decides the time of turning on and off the device;

11. The method of claim 6, wherein a receiving device receives the predetermined amount of the compressed packs of audio data and decides the time of turning on and off the device;

12. The method of claim 6, wherein an audio compression device compresses the predetermined amount of the audio samples and decides the time of turning on and off the device;

13. The method of claim 6, wherein an audio decompression device decompresses the predetermined amount of the audio samples and decides the time of turning on and off the device;

14. A method of error correction in audio data playback through wireless data transmission, comprising:
receiving the compressed audio data through a wireless receiver;
checking the amount of the compressed audio data to determine whether audio data loss happened or not;
if data loss happened, taking a procedure from the following error correction mechanisms:
requesting the transmission device to re-send the lost pack of audio data; or
repeating at least one of the recovered audio sample to represent the lost audio data within a pack of audio; or
repeating the last audio sample of previous pack of audio if the length of pack of audio data is shorter than a predetermined amount of audio samples; or
taking the inserted average values as references to recover the targeted lost audio samples; or
taking the inserted average values to represent the targeted lost audio samples;

15. The method of claim 14, wherein when the amount of audio data loss within a pack of audio data is within a predetermined threshold number, the decompression engine finishes the decoding procedure and repeats the last audio sample to fill up the length of the audio pack.

16. The method of claim 14, wherein when plurality of audio data lost within a pack of audio data, in an average duration time, the recovered audio samples are repeated to represent the lost audio samples.
